(19) United States
(12) Patent Application Publication
(10) Pub. No.: US 2003/0105836 A1
(43) Pub. Date: Jun. 5, 2003

(54) Device and method for specifying location of object in distributed object system

(75) Inventor: Yasushi Higuchi, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/289,431

(22) Filed: Nov. 7, 2002

(30) Foreign Application Priority Data
Nov. 30, 2001 (JP) 2001-366594

(51) Int. Cl. G06F 15/16

(52) U.S. Cl. 709/219

(57) ABSTRACT

Server newly connected to a distributed object system generates a list for access to an object usable in the system, thereby enabling all the servers to communicate with each other using the list. In addition, a server finding a server stopping in the distributed object system is allowed to update the list for access to a usable object.

### BACKGROUND OF THE INVENTION

1. Field of the Invention

The present invention relates to a device, a method and a program for specifying a location of an object in a distributed object system.

2. Description of the Related Art

In a conventional computer system, a distributed object system making use of distributed object techniques has been used. Distributed objects are a mass of software which can be functioned distributedly on a plurality of computers and which operate in a unique manner with a unique value. More specifically, the distributed objects provide a technique for realizing environments in which objects on respective computers mutually operate through a network or for sharing software resources with ease.

Use of distributed object techniques mainly have the following two merits. One is enabling development of high level system with low costs. The other is enabling a distributed system to be set up with ease because even with a complicated system which should be distributed into a plurality of computers, objects can be located freely.

In the above-described distributed object techniques, a provider of service or function is called “server” and a consumer of service or function is called “client”. Distributed object may exist at an arbitrary location in a network, for example, in a client's address space, in a multi address space on a client machine, or in a machine of the whole network.

In addition, in such an object model, a client and a server are roles and in general not inter-exclusive tasks for a single program. In other words, a certain computer (object) can serve as a client for certain processing and as a server for other processing.

In distributed object techniques, each object is managed by its name in many cases. Such arrangement produces an advantage that even when a certain object is to be moved onto a completely different computer, it is only necessary to modify information of a data base for object search. In other words, no client will be affected by environmental change at all.

Among distributed object techniques using such mechanism as described above is CORBA (Common Object Request Broker Architecture) standardized with OMG (Object Management Group).

In CORBA, an object specifies a location of other object on ORB (Object Request Broker) by naming service. ORB is a mechanism for realizing transmission and reception between objects under distributed environments and mediates communication between a client object and a server object.

In more detailed description, naming service employs a data base for object search called naming context. Naming context forms information of an object reference which can uniquely indicate a name and a type of an object and a distributed object as a unit called record. Object reference is an identifier necessary for activating a method of an object. By obtaining the information, a client is allowed to make a request for a target object. Accordingly, operation of a naming context including an object reference enables management of a distributed object by name. Name is a value for identifying an object which is recognizable by a person.

As described in the foregoing, according to such a distributed object technique as CORBA, with one computer as a naming server in CORBA, naming service is provided to exchange object references (CORBA object reference).

The above-described conventional techniques, however, have a problem that since when a naming server stops for one reason or another, a client object is not allowed to obtain an object reference, communication with a server object is disabled. In other words, although a distributed object technique is employed, naming service is concentrated on a naming server.

### SUMMARY OF THE INVENTION

The present invention, which is intended to solve the above-described problems, is to provide a server, a method and a program for setting up, for example, a distributed object system requiring no naming server to therefore have no risk of naming server down, which is realized by generating a list for access to an object usable in the system by a server newly connected to the distributed object system and using the list by all the servers to communicate.

Another object is to provide a server, a method and a program allowing a server which finds a server stopping in a distributed object system to update a list for access to a usable object, thereby enabling information of an object usable in the system to be updated at any time without, for example, requiring a naming server.

According to the first aspect of the invention, a method of specifying a location of an object in a distributed object system, comprising the steps of

a step, by one server connected to the distributed object system, of transmitting, to other server, an information return request for requesting transmission of information necessary for accessing an owned object,

a step, by a server having received the information return request, of transmitting information necessary for accessing an object owned by the server in question to the one server,

a step, by the one server, of generating a list of information necessary for access to an object in the distributed object system based on information returned from other server, and

a step, by the one server, of transmitting the list to the other server, thereby conducting communication between objects in the distributed object system by using the list.

As the information, IOR (Interoperable Object Reference) including an object reference, for example, can be adopted.

By the foregoing steps, each server conducts communication between objects in the distributed object system by using the above-described list.

In other words, making any one of servers, a server newly connected to the distributed object system, in particular, generate the above-described list and setting the list to all the servers of the system enables the respective servers to use their objects with each other.

In the preferred construction, the information return request is transmitted by the one server at the time of activation.

In another preferred construction, the information return request is transmitted by the one server at the time of activation, and

any one of servers has the steps of:

sensing any, server connected to the distributed object system to stop,

deleting information necessary for access to an object owned by the stopping server from the list, and

notifying each server connected to the distributed object system of a deletion request for deleting information necessary for access to an object owned by the stopping server from the list.

The foregoing steps enable each server to communicate using a latest list at any time even when a server constituting the system goes down.

In another preferred construction, any one of servers has the steps of

sensing any server connected to the distributed object system to stop,

deleting information necessary for access to an object owned by the stopping server from the list, and

notifying each server connected to the distributed object system of a deletion request for deleting information necessary for access to an object owned by the stopping server from the list.

In another preferred construction, a server having received the deletion request has the step of deleting information necessary for access to an object owned by the stopping-server from the list according to the deletion request

According to the second aspect of the invention (recited in claim 6), a server for conducting communication between objects in a distributed object system, comprises

information collection means for requesting, from each other server connected to the distributed object system, transmission of information necessary for accessing an object owned by the server in question,

means for generating a list of information necessary for access to an object in the distributed object system based on information returned from each the server, and

means for transmitting the list to each the server, thereby conducting communication between objects in the distributed object system by using the list.

In the preferred construction, the information collection means is activated when the server is activated.

In another preferred construction, the server for conducting communication between objects in a distributed object system further comprises

means for sensing any server connected to the distributed object system to stop,

deletion means for deleting information necessary for access to an object owned by the stopping server from the list, and

means for notifying each server connected to the distributed object system of a deletion request for deleting information necessary for access to an object owned by the stopping server from the list, thereby conducting communication between objects in the distributed object system by using the list generated by the deletion means.

According to the third aspect of the invention (recited in claim 9), a server for conducting communication between objects in a distributed object system, comprising:

means for receiving, from other server, a return request of information necessary for access to an owned object,

means for transmitting information necessary for access to an owned object to a server as a transmission source of the return request, and

means for receiving a list including information necessary for access to an object owned by each server from a return request transmission source server, wherein

the list is used as a list for communication between objects in the distributed object system.

When connected to the distributed object system constituted by the above-described server (recited in claim 9), the above-described server (recited in claim 6) is allowed to conduct communication between objects by generating the above-described list.

On the other hand, by using the list received from the first server (recited in claim 6), the second server (recited in claim 9) is allowed to communicate using the latest list at any time.

In other words, when the first server (recited in claim 6) is connected, the distributed object system to which the second server (recited in claim 9) is connected is allowed to update the above-described list of each server without a naming server.

Each server preferably has a function (means) of the first server (recited in claim 6) and a function (means) of the second server (recited in claim 9). This is because constituting the distributed object system by such servers enables the system to automatically put a newly connected server to a usable state.

In addition, an information collection means is preferably activated when a server is activated. This is because when a server is connected, this setting makes an object of the server in question be usable. The server is also allowed to use an object that other server owns.

In the preferred construction, the server (recited in claim 10) for conducting communication between objects in a distributed object system further comprises means for sensing any server connected to the distributed object system to stop, deletion means for deleting information necessary for access to an object owned by the stopping server from the list, and means for notifying each server connected to the distributed object system of a deletion request for deleting information necessary for access to an object owned by the stopping server from the list, thereby conducting communication between objects in the distributed object system by using the list generated by the deletion means.

In other words, by preventing access to an object of a stopping server, a third server (recited in claim 10) is allowed to communicate under latest environments all the time.

According to another aspect of the invention, a server for conducting communication between objects in a distributed object system, comprises

information collection means for transmitting, to each other server connected to the distributed object system, an information return request for requesting transmission of information necessary for accessing an object owned by the server in question,

generation means for generating a list of information necessary for access to an object in the distributed object system based on information returned from each the server,

means for transmitting the list to each the server,

means for receiving an information return request from other server,

means for transmitting information necessary for access to an owned object to a server as a transmission source of the information return request, and

reception means for receiving a list including information necessary for access to an object owned by each server from a transmission source server of the information return request, wherein

as a list for communication between objects in the distributed object system,

at an initial state, a list generated by the generation means is used and

when receiving a list by the reception means, the list in question is used.

In the preferred construction, the information collection means is activated when the server is activated.

According to another aspect of the invention, the server for conducting communication between objects in a distributed object system as set forth in claim 11, further comprises

means for sensing any server connected to the distributed object system to stop,

deletion means for deleting information necessary for access to an object owned by the stopping server from the list, and

means for notifying each server connected to the distributed object system of a deletion request for deleting information necessary for access to an object owned by the stopping server from the list, thereby conducting communication between objects in the distributed object system by using the list generated by the deletion means.

In the preferred construction, the server (recited in claim 14) for conducting communication between objects in a distributed object system further comprises

means for receiving the deletion request, and

means for deleting information necessary for access to an object owned by the stopping server from the list according to the deletion request.

In a system to which at least one of third servers (recited in claim 10) is connected, a fourth server (recited in claim 14) can be set not to access an object of a stopping server when receiving a deletion request from the third server (recited in claim 10).

Even when there exists a stopping server, the system composed of the third server (recited in claim 10) and the fourth server (recited in claim 14) is thus allowed to seize a usable object without provision of a naming server.

This is because when any of the servers detects other server going down, the system constituted by servers having a function (means) of the third server (recited in claim 10) and a function (means) of the fourth server (recited in claim 14) preferably makes an object of the down server be unusable.

This is also because when a new server is connected or when a constituent server stops as well, the system constituted by servers having all the functions (means) of the first (recited in claim 6) to fourth servers (recited in claim 14) enables a list of usable objects to be the latest all the time.

According to another aspect of the invention, a server for conducting communication between objects in a distributed object system, comprises

means for sensing any server connected to the distributed object system to stop,

deletion means for deleting information necessary for access to an object owned by the stopping server from a list of information necessary for access to an object in the distributed object system, and

means for notifying each server connected to the distributed object system of a deletion request for deleting information necessary for access to an object owned by the stopping server from the list of information necessary for access to an object in the distributed object system which list is owned by each server, thereby conducting communication between objects in the distributed object system by using the list generated by the deletion means.

In the preferred construction, the server for conducting communication between objects in a distributed object system further comprises

means for receiving the deletion request, and

means for deleting information necessary for access to an object owned by the stopping server from the list according to the deletion request.

According to another aspect of the invention, a program for controlling a computer to cause the computer to function as a server for conducting communication between objects in a distributed object system, comprising the functions of

an information collection function of requesting, from each other server connected to the distributed object system, transmission of information necessary for accessing an object owned by the server in question,

a function of generating a list of information necessary for access to an object in the distributed object system based on information returned from each the server, and

a function of transmitting the list to each the server, thereby conducting communication between objects in the distributed object system by using the list.

According to a further aspect of the invention, a program for controlling a computer to cause the computer to function as a server for conducting communication between objects in a distributed object system, comprising the functions of

receiving, from other server, a return request of information necessary for access to an owned object,

transmitting information necessary for access to an owned object to a server as a transmission source of the return request, and

receiving a list including information necessary for access to an object owned by each server from a return request transmission source server, wherein

the list is used as a list for communication between objects in the distributed object system.

According to a further aspect of the invention, a program for controlling a computer to cause the computer to function as a server for conducting communication between objects in a distributed object system, comprising the functions of

an information collection function of transmitting, to each other server connected to the distributed object system, an information return request for requesting transmission of information necessary for accessing an object owned by the server in question,

a generation function of generating a list of information necessary for access to an object in the distributed object system based on information returned from each the server,

a function of transmitting the list to each the server,

a function of receiving an information return request from other server,

a function of transmitting information necessary for access to an owned object to a server as a transmission source of the information return request, and

a reception function of receiving a list including information necessary for access to an object owned by each server from a server as a transmission source of the information return request, wherein

as a list for communication between objects in the distributed object system,

at an initial state, a list generated by the generation means is used and

when receiving a list by the reception function, the list in question is used.

According to a still further aspect of the invention, a program for controlling a computer to cause the computer to function as a server for conducting communication between objects in a distributed object system, comprising the functions of

a function of sensing any server connected to the distributed object system to stop,

a deletion function of deleting information necessary for access to an object owned by the stopping server from a list of information necessary for access to an object in the distributed object system, and

a function of notifying each server connected to the distributed object system of a deletion request for deleting information necessary for access to an object owned by the stopping server from the list of information necessary for access to an object in the distributed object system which list is owned by each server, thereby conducting communication between objects in the distributed object system by using the list generated by the deletion function.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a diagram showing an example of a structure of a distributed object system according to the present invention;

FIG. 2 is a diagram showing a relation between a client object and a server object, which is an expansion of a part of FIG. 1;

FIG. 3 is a sequence diagram showing an IOR collection sequence and an IOR list transmission sequence in the system illustrated in FIG. 1;

FIG. 4 is a sequence diagram showing an IOR update sequence in the system illustrated in FIG. 1;

FIG. 5 shows an example of a protocol stack in a system in which UDP is used as a protocol of a transport layer for use in message transmission in the IOR collection sequence, the IOR list transmission sequence and the IOR update sequence in the system illustrated in FIG. 1;

FIG. 6 is a diagram showing an example of operation of a program (IOR list management demon) realizing the IOR collection sequence, the IOR list transmission sequence and the IOR update sequence in the system illustrated in FIG. 1;

FIG. 7 shows an example of an IOR list in the server at the time of activation (initial state) in the system shown in FIG. 1;

FIG. 8 shows an example of the IOR list in the server at a normal state in the system illustrated in FIG. 1, which is an example of the IOR list in a case where the distributed object system is composed of servers A to N;

FIG. 9 shows an example of the IOR list obtained after the IOR update sequence is executed because the server B stops in the system illustrated in FIG. 1, which is an example of the IOR list generated when the server B stops in FIG. 8;

FIG. 10 is a diagram showing how a certain server generates the IOR list in the system of FIG. 1, which shows one example of the IOR list when the IOR collection sequence and the IOR list transmission sequence are being executed; and

FIG. 11 is a diagram showing an example of a protocol stack in the system of FIG. 1 in which TCP is used as a protocol of the transport layer for use in message transmission in the IOR collection sequence, the IOR list transmission sequence and the IOR update sequence.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

In the following, detailed description will be made of a device, a method and a program for specifying a location of an object in a distributed object system according to the present invention with respect to an embodiment. First, the device will be described with reference to the drawings. The following description will be made taking a system adopting CORBA as a distributed object technique (distributed object system) as an example.

(Device)

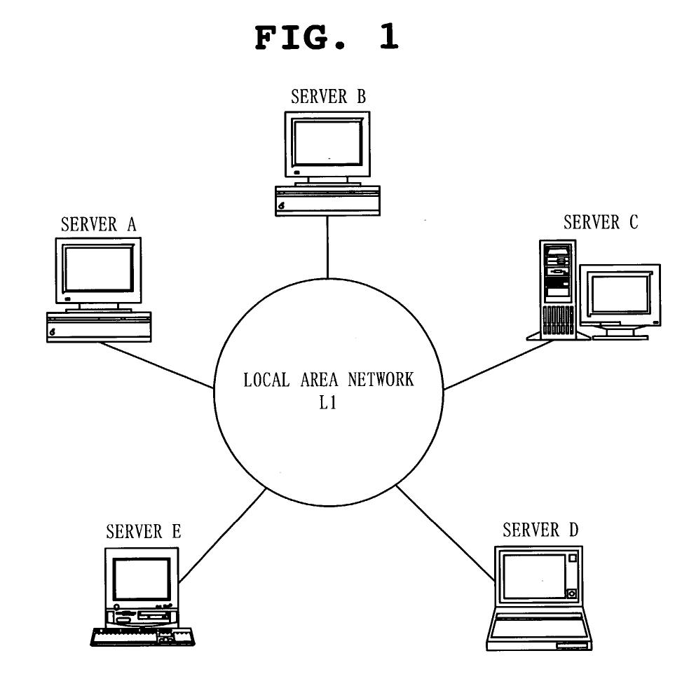

FIG. 1 shows an example of a typical network structure of the distributed object system according to the present invention. To a local area network (LAN) L1, servers A, B, C, D and E are connected.

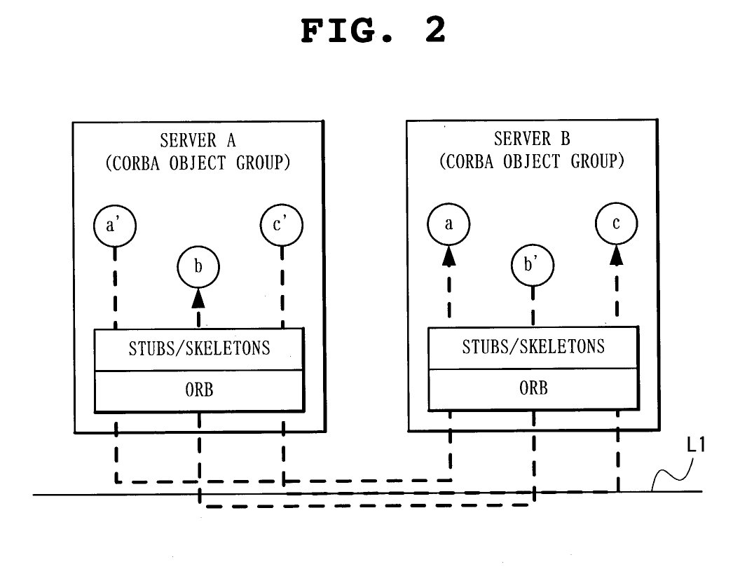

FIG. 2 shows an example of object arrangement of the servers A and B and the local area network L1 in the network illustrated in FIG. 1.

In FIG. 2, one server has a plurality of CORBA objects and communicates with other server through the local area network L1. More specifically, a method calling object (client object) in the server transmits a message to a server object in other server. This communication is conducted through an ORB and each object has a program (interface unit) adapted to the specification of the ORB. The interface unit includes a code unit (skeleton) for receiving a request from other object and a code unit (stub) for transmitting a message to other object.

In FIG. 2, the server A has a CORBA object b and the server B has CORBA objects a and c. With respect to the CORBA objects a and c, the server A serves as a CORBA client and the server B serves as a CORBA server. With respect to the CORBA object b, the server A serves as the CORBA server and the server B serves as the CORBA client. In FIG. 2, client object (method calling object) is attached ['] to discriminate it from a server object.

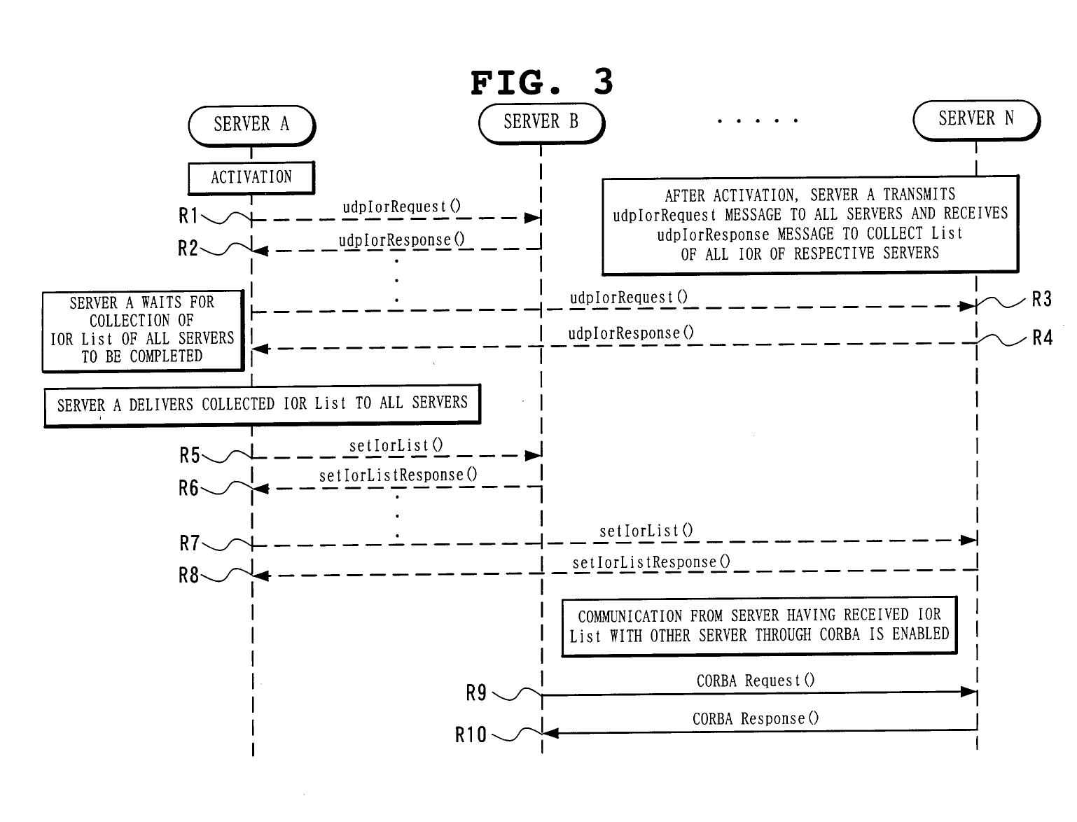

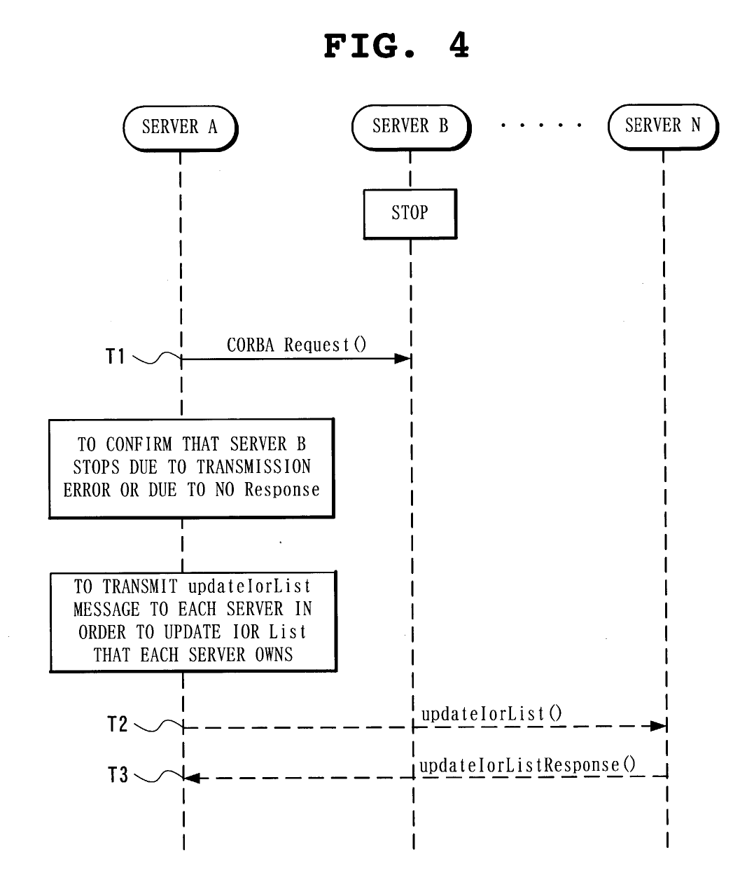

Procedure of exchanging object references without using a naming server (naming service) in the above-described system will be described with reference to FIGS. 3 and 4.

FIG. 3 shows a message sequence (IOR collection sequence) for obtaining an object reference from all the servers and a message sequence (IOR transmission sequence) for distributing a latest IOR to all the object references of all the servers.

(IOR Collection Sequence)

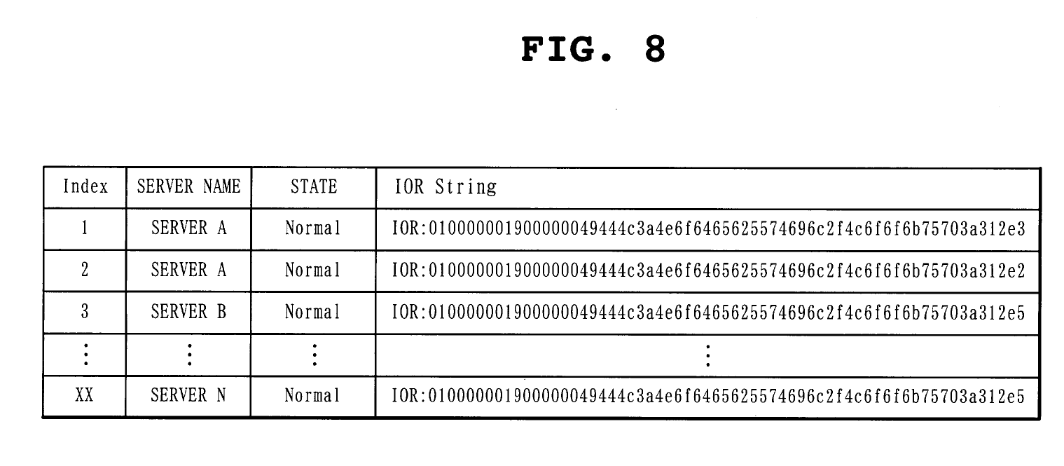

The IOR collection sequence is triggered by the activation of a server. In the present example, description will be made of the sequence in a case where the server A is activated. FIG. 7 shows an initial state of an IOR list A2 of the server A. As shown in FIG. 7, the server A has not completed the IOR list A2 immediately after activation (initial state). In FIG. 7, the IOR list A2 includes information about a machine name (server name), an IOR acquisition state of the server and an actual character string of the IOR and is capable of storing all the machines and all the object references.

The server A transmits a udpIorRequest message to all the servers after activation (R1, R3). The udpIorRequest message is a message requesting return of an object reference that a receiver of the message has (object reference request message).

Server as a transmission destination of the udpIorRequest message may be, for example, a preset server. In this case, each server is assumed to have an IP address and a port number of other server set in advance.

It is also possible to transmit a broadcast message for obtaining an IP address of a target server and transmit the udpIorRequest message to a server responding to the broadcast message. In other words, the server A has a function of transmitting the broadcast message and a function of transmitting the udpIorRequest message to a server which has responded to the message. Other server has a function of responding, upon receiving the broadcast message, to the server A (server as a transmission source of the message). Each server is preferably designed to have all these functions.

The server B . . . server N (servers other than the server A in the system) having received the udpIorRequest message transmit a udpIorResponse message which stores its object reference as a factor to the server A (R2, R4). The udpIorResponse message is a return message to the object reference request message and includes an object reference of a server having received the object reference request message.

By the foregoing procedures, the server A collects an IOR (Interoperable Object Reference) of a CORBA object each server owns. The IOR includes information necessary for access to a server program (server object) that provides service, which information, more specifically, is composite information including an IP address, a host name, a process ID and process generation time.

The server A sets up (updates) the IOR list A2 by using the collected IOR.

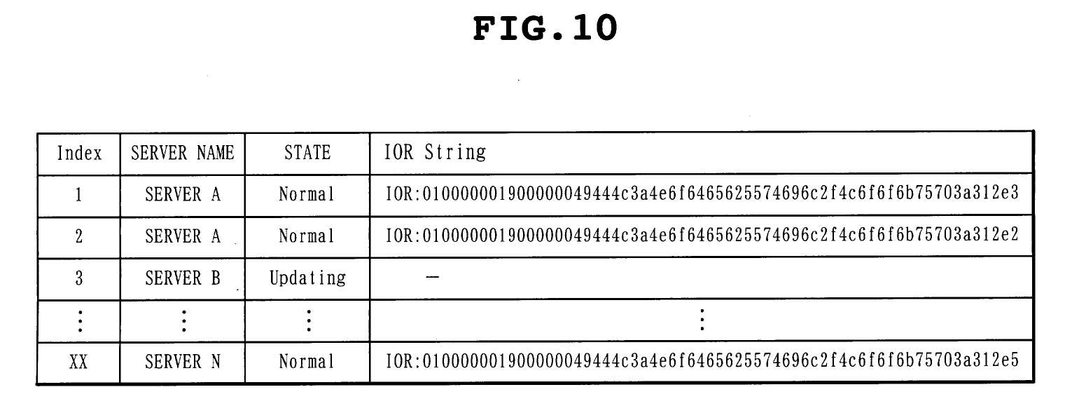

FIG. 10 shows one example of the IOR list A2 being updated. In FIG. 10, the IOR list A2 represents that the IOR of the server B is not obtained. As shown in the figure, a server whose IOR is yet to be completely acquired has the column of [state] indicated as [Updating] in FIG. 10. In addition, a server whose IOR is completely acquired has the column of [state] indicated as [Normal] in FIG. 10.

In other words, in FIG. 10, the server A is obtaining or yet to obtain the IOR of the server B and has already obtained the IOR of the server N (already registered in the IOR list).

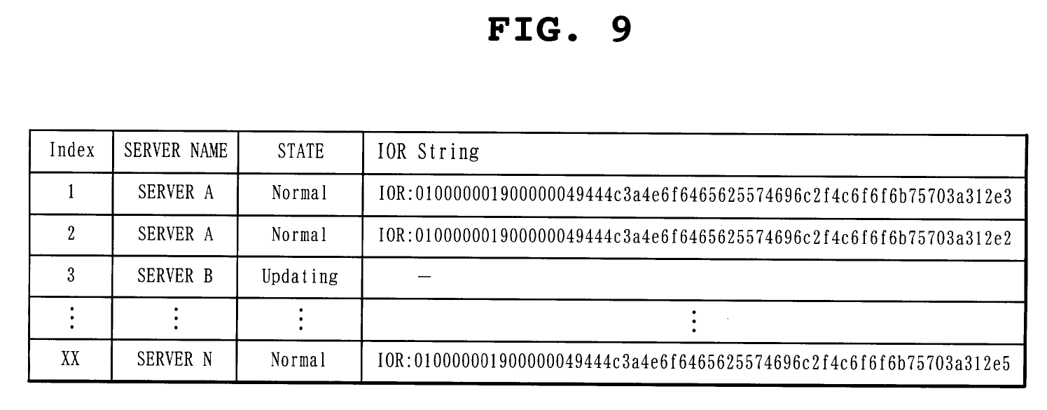

FIG. 8 shows the IOR list A2 at a state where collection of all the IOR is completed. In FIG. 8, the column of [state] of each server is all indicated as [Normal].

(IOR List Transmission Sequence)

After the collection of the IOR from all the servers is completed, the server A transmits a setIorList message which stores the collected IOR list in a factor to all the servers (R5, R6). In other words, the server A transmits a message including such IOR list A2 as shown in FIG. 8 to all the servers.

Server having received the setIorList message finds an IOR that other server owns from the factor of the message. The server accordingly stores the IOR of each server in its own IOR list.

The server B, for example, sets up an IOR list B2 for the server B based on the IOR list As included in the setIorList message. More specifically, using such IOR list A2 generated by the server A as shown in FIG. 8, the server B updates the IOR list as of before connection of the server A to the network into the IOR list as of after connection of the server A to the network. For the update of the IOR list, an arbitrary method can be adopted such as update of the IOR list A2 into the IOR list B2. This results in having the IOR lists of all the servers updated to the same contents as the IOR lists A2. It is also possible to update only a server which has different IOR before and after the connection of the server A. In other words, it is possible to update only an IOR list of a server as a setIorList message transmission source (server A in this example). This produces a possibility that time required for updating the IOR list will be reduced.

Server with an IOR stored in the setIorList set may notify the server A that setting is completed (setIorListResponse, R6, R8).

Through the foregoing sequences, all the object references will be delivered to the respective servers. Each server is accordingly allowed to communicate using CORBA (through the ORB). In other words, each server has a latest IOR set and is allowed to use objects of the respective servers including the server A.

More specifically, because each server owns such an IOR list as shown in FIG. 8, it finds a state of the IOR and a character string of the same of each server, so that it can obtain an IOR of a CORBA object to which a message is to be transmitted.

Next, description will be made of an IOR list update sequence in a case where an arbitrary server removes from the distributed object system with reference to FIG. 4.

(IOR List Update Sequence)

FIG. 4 shows an example in a case where the server B stops for one reason or another. In other words, it shows an example in a case where the server B removes from the distributed object system.

In such a case, the IOR of the server B is made unusable to require update of the IOR list. More specifically, it is necessary to update such an IOR list as shown in FIG. 8 into such an IOR list as shown in FIG. 9 in which the IOR of the server B is deleted.

FIG. 4 shows a change (update) sequence of this IOR list.

In FIG. 4, the sequence is triggered by transmission of any CORBA message by the server A to the server B after the server B stops (Ti). Since the server B stops, the message transmission will fail or no response to the message will return to the server A. When sensing such a phenomenon derived from stoppage of the server B, the server A determines that the server B stops.

Upon determining that the server B stops, the server A notifies servers other than the server B that the object of the server B is invalidated (updateIorList message, T2). In addition, update the IOR list A2 shown in FIG. 8 into the IOR list shown in FIG. 9. More specifically, modify the IOR list as of before the server B stops into the IOR list in the distributed object system as of after the server B stops.

The server having received the notification updates the IOR list A2 shown in FIG. 8 into the IOR list shown in FIG. 9. In other words, change the IOR list to have the IOR of the server B deleted. The server A (server as updateIorList message transmission source) may be notified that update of the IOR list is completed (updateIorListResponse message, T3).

The foregoing sequence enables an IOR for the communication with the server B to be invalidated.

Next, description will be made of a method of specifying a location of an object in the distributed object system according to the present invention.

(Method)

Method of specifying a location of an object in the distributed object system is composed of the following steps of:

(1) causing one server connected to the distributed object system to transmit, to other server, an information return request for requesting the transmission of an IOR,

(2) causing a server having received the information return request to transmit the IOR of the server in question to the one server,

(3) causing the one server to generate an IOR list based on the IOR returned from other server, and

(4) causing the one server to transmit the IOR list to other servers.

In other words, Steps (1) to (3) correspond to the IOR collection sequence and Step (4) corresponds to the IOR list transmission sequence.

Each server in the system communicates using the IOR list.

Even a new server is connected to the system, adoption of this method enables each server to use an object that the newly connected server owns. This also enables the newly connected server to use usable objects (objects owned by other servers) in the system.

The information return request is preferably transmitted by the one server at the time of activation. This is because the time of activation of the server corresponds to the time of connection of the server to the distributed object system. Transmission may be conducted at other time. The request may be transmitted, for example, when the one server actually uses an object of other server. This is because the above-described list should be generated prior to actual use.

Moreover, the above-described method preferably has the following steps of:

(5) causing any one of the servers (which is not limited to the above-described one server) to detect any server connected to the distributed object system stopping,

(6) causing the any one server to delete the IOR of the stopping server from the list,

(7) causing the any one server to notify the respective servers (servers excluding the any one server and the stopping server) connected to the distributed object system of a deletion request for deleting the IOR of the stopping server from the list, and

(8) causing a server having received the deletion request to delete information necessary for access to the object that the stopping server owns from the list according to the deletion request.

Even when a server forming the system goes down, the foregoing steps enable each server to communicate using a latest list at any time. In other words, a usable object can be precisely seized at any time.

The above-described method can be realized by using, for example, the above-described device. Application of this method, however, is not limited to the above-described device as a matter of course.

Next, description will be made of a program, that is, an IOR management demon, for specifying a location of an object in the distributed object system according to the present invention.

(IOR Management Demon)

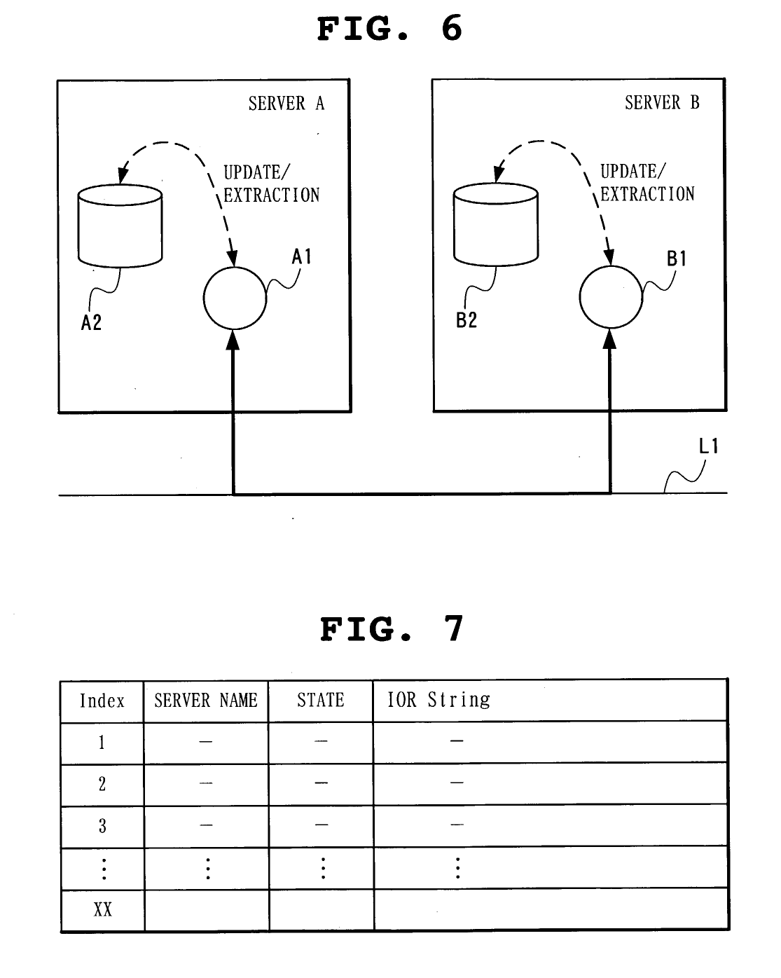

The IOR management demon according to the present invention is a program which realizes a function as the above-described device (server) on a computer. In other words, it is a program for making the computer execute the above-described method. Relationship between the program and the servers (distributed object system) is shown in FIG. 6.

In FIG. 6, each server has an IOR list management demon A1 or B1 for transmitting and receiving a message to and from other server and updating/extracting an IOR and a storage means such as a memory for storing the IOR list A2 or B2.

As shown in FIG. 6, each server is capable of communication between the IOR list management demons with other machine through the local area network L1. In addition, the IOR list management demon is capable of updating/extracting an IOR in/from the IOR list existing in the memory. More specifically, the IOR management demons A1 and B1 respectively cause the computer to realize the following processing.

(IOR Collection Sequence)

As shown in FIG. 3, the IOR management demon A1 causes the computer (server A) to transmit the udpIorRequest message to all the servers after the server A is activated (R1, R3).

When the server B (computer) receives the udpIorRequest message, the IOR management demon B1 stored in the computer causes the computer to transmit the IOR B2 to the computer (server A) in which the IOR management demon A1 is stored.

Also in other servers, each IOR management demon B1 causes its server to transmit its IOR of the server to the server A.

The IOR management demon A1 causes the server A to set up the IOR list A2 using the received IOR.

(IOR List Transmission Sequence)

After collection of IOR from all the servers is completed, the IOR management demon A1 causes the server A to transmit the setIorList message having the collected IOR list stored in a factor to all the servers (R5, R6).

The IOR management demon B1 of the server B having received the setIorList message makes the IOR list included in the setIorList be its own IOR list B2. More specifically, the demon makes the received IOR list be stored in the storage means such as a memory to consider it as the IOR list B2.

Also in other servers having received the setIorList message, the IRO management demon B1 conducts the same processing.

The IOR management demon B1 having the IOR stored in the setIorList set may cause the server to notify that setting to the server A is completed (setIorListResponse, R6, R8).

As a result of the foregoing processing, each server has a latest IOR set and is allowed to use objects of respective servers including the server A.

In addition, the IOR list update sequence may be realized by the computer.

(IOR List Update Sequence)

As shown in FIG. 4, when the server B stops for one reason or another, the IOR of the server B is rendered unusable, so that the IOR list should be updated. In this case, the IOR management demon conducts the following processing.

In FIG. 4, when sensing a phenomenon derived from stoppage of the server B, the IOR management demon A1 determines that the server B stops and causes the server A to notify servers other than the server B that the object of the server B is invalidated (updateIorList message, T2).

In addition, the demon causes the server A to update the IOR list A2 shown in FIG. 8 into the IOR list shown in FIG. 9. More specifically, update the IOR list as of before the server B stops into the IOR list of the distributed object system as of after the server B stops.

The IOR management demon of the server having received the notification updates its own IOR list to be the same as the IOR list included in the received notification. The server A (server as updateIorList message transmission source) may be notified of completion of update of the IOR list

(updateIorListResponse message, T3).

The foregoing sequence enables the IOR for the communication with the server B to be invalidated.

It is naturally preferable that the IOR management demon causes the computer to execute a function that each IOR management demon (A1, B1, etc.) causes the computer to realize. In other words, irrespective of distinction of the IOR management demons A1, B1, etc., every one of the above-described processing is preferably a program which can be realized by the computer.

This is because such a program enables a list of usable objects to be the latest at any time even when a new server is connected or when a constituent server stops.

Although the preferred embodiment of the present invention has been described, it is clearly understood that the embodiment is by way of illustration and an example of the invention only and is not to be taken by way of limitation of the spirit and scope of the present invention to the embodiment. Those skilled in the art are allowed to implement the present invention in various other modes in which various change, modification, simplification, etc. are made in the embodiment.

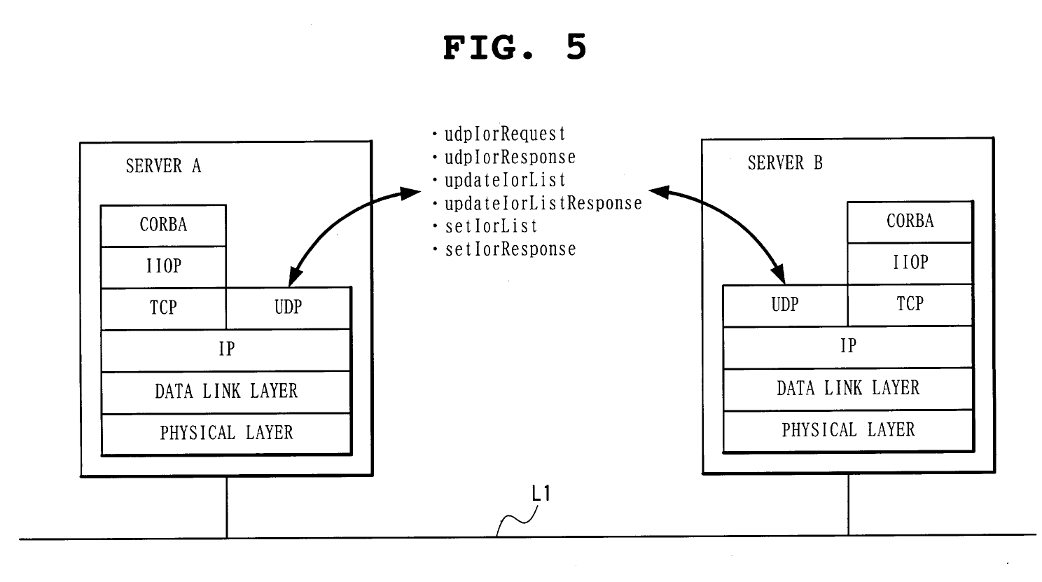

For example, as shown in FIG. 5, each of the above-described messages may be transmitted or received through a UDP (User Datagram Protocol) on a protocol stack.

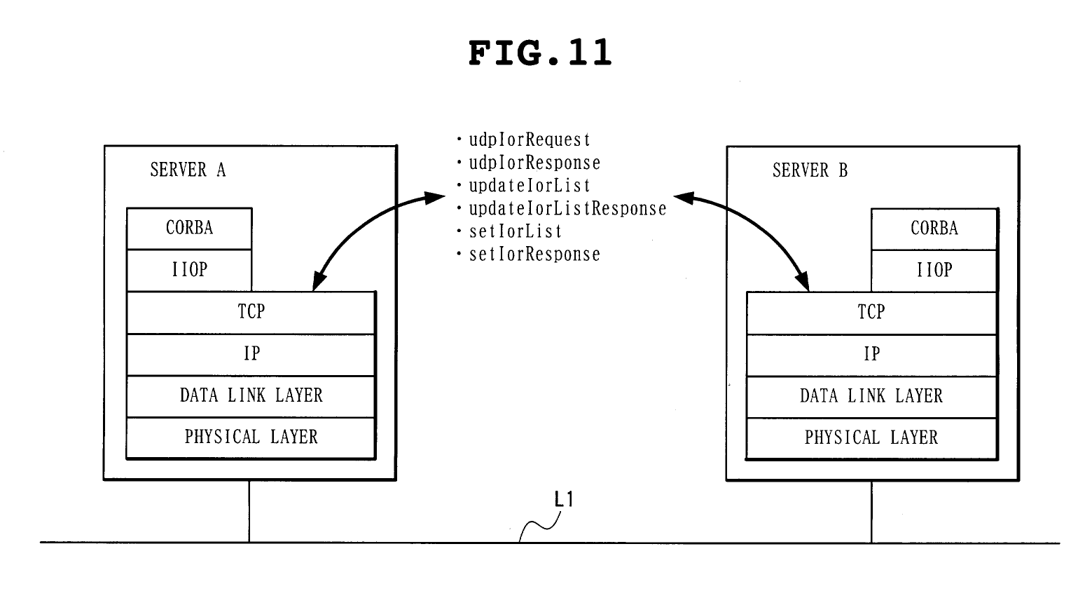

In addition, as shown in FIG. 11, each of the messages may be transmitted or received through a TCP (Transmission Control Protocol). In other words, as a protocol corresponding to a transport layer of an OSI basic reference model, an arbitrary protocol may be used. Thus using a connection type protocol enables reliable transmission of a message to a partner server. When such a connection type protocol as TCP is adopted, connection should be normally cut off because connection with other server is maintained. Connection cut-off may be conducted by an ordinary method.

Moreover, although the foregoing description has been made assuming that the IOR collection sequence is executed after a server is activated, setting may be made to execute the sequence at arbitrary timing such as at the time of use of the distributed object after the connection to the network is made.

Furthermore, with a naming server (naming service) used, the present invention may be applied when the naming server stops. More specifically, when the naming server normally operates, the present invention will not be applied and when the same stops, the present invention will be applied. With this arrangement, while using conventional service, the system can be operated even when the service stops.

In this case, a server determining that the naming server stops may start the IOR collection sequence. When a server newly added to the system determines that the naming server is unusable, it may start the IOR collection sequence. Upon start of the sequence, other servers may determine that the naming server is at an unusable state to switch to the processing by the above-described sequence. Determination that the naming server is unusable can be made by an arbitrary method. Determination of unusability can be made when, for example, no response is made from the naming server or when connection is impossible.

In addition, when returning to a usable state, the naming server may notify each server to that effect and each server may start processing using the naming service.

As is clearly understood from the foregoing description, in communication between a client object and a server object using such a distributed object technique as CORBA, all the object references of a plurality of servers can be efficiently exchanged to enable communication between objects without providing a naming server. The following three effects are attained, for example.

First effect is distributing to each server an object reference for use therein without using naming service.

This effect prevents stoppage of a naming server etc. from hindering object reference acquisition and accordingly from rendering communication between objects impossible.

In a conventional system, although it adopts a distributed object technique, processing of finding a component (object) connected by an ORB by it name is taken charge of only by one server (naming server). Therefore, the naming server down leads to system down.

Adoption of the present invention accordingly enables elimination of such a problem.

Second effect is that all the servers can automatically update their IOR when a certain server stops.

Since according to the present invention, a server having found a stopping server starts the IOR list update sequence even without provision of a server for monitoring state of each server, the IOR lists of all the servers can be updated.

Third effect is enabling a latest IOR list to be maintained at any time because the IOR list is updated immediately after activation of a server.

Since a server connected to the system starts the IOR collection sequence and then executes the IOR list transmission sequence, the IOR list of each server can be maintained to be the latest without provision of a server for monitoring the server connected to the system.

As described in the foregoing, the present invention enables all the object references of a plurality of servers to be efficiently exchanged to realize communication between servers without provision of a naming server.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

In the claims:

1. A method of specifying a location of an object in a distributed object system, comprising the steps of:
a step, by one server connected to the distributed object system, of transmitting, to other server, an information return request for requesting transmission of information necessary for accessing an owned object,
a step, by a server having received said information return request, of transmitting information necessary for accessing an object owned by the server in question to said one server,
a step, by said one server, of generating a list of information necessary for access to an object in the distributed object system based on information returned from other server, and
a step, by said one server, of transmitting said list to said other server, thereby conducting communication between objects in the distributed object system by using said list.

2. The method of specifying a location of an object in a distributed object system as set forth in claim 1, wherein
said information return request is transmitted by said one server at the time of activation.

3. The method of specifying a location of an object in a distributed object system as set forth in claim 1, wherein
said information return request is transmitted by said one server at the time of activation, and
any one of servers has the steps of:
sensing any server connected to the distributed object system to stop,
deleting information necessary for access to an object owned by said stopping server from said list, and
notifying each server connected to the distributed object system of a deletion request for deleting information necessary for access to an object owned by said stopping server from said list.

4. The method of specifying a location of an object in a distributed object system as set forth in claim 1, wherein
any one of servers has the steps of:
sensing any server connected to the distributed object system to stop,
deleting information necessary for access to an object owned by said stopping server from said list, and
notifying each server connected to the distributed object system of a deletion request for deleting information necessary for access to an object owned by said stopping server from said list.

5. The method of specifying a location of an object in a distributed object system as set forth in claim 4, wherein
a server having received said deletion request has the step of deleting information necessary for access to an object owned by said stopping server from said list according to said deletion request.

6. A server for conducting communication between objects in a distributed object system, comprising:
information collection means for requesting, from each other server connected to the distributed object system, transmission of information necessary for accessing an object owned by the server in question,
means for generating a list of information necessary for access to an object in the distributed object system based on information returned from each said server, and
means for transmitting said list to each said server, thereby conducting communication between objects in the distributed object system by using said list.

7. The server for conducting communication between objects in a distributed object system as set forth in claim 6, wherein
said information collection means is activated when the server is activated.

8. The server for conducting communication between objects in a distributed object system as set forth in claim 6, further comprising:
means for sensing any server connected to the distributed object system to stop,
deletion means for deleting information necessary for access to an object owned by said stopping server from said list, and
means for notifying each server connected to the distributed object system of a deletion request for deleting information necessary for access to an object owned by said stopping server from said list, thereby conducting communication between objects in the distributed object system by using the list generated by said deletion means.

9. A server for conducting communication between objects in a distributed object system, comprising:
means for receiving, from other server, a return request of information necessary for access to an owned object,
means for transmitting information necessary for access to an owned object to a server as a transmission source of said return request, and
means for receiving a list including information necessary for access to an object owned by each server from a return request transmission source server, wherein
said list is used as a list for communication between objects in the distributed object system.

10. The server for conducting communication between objects in a distributed object system as set forth in claim 9, further comprising:
means for sensing any server connected to the distributed object system to stop,
deletion means for deleting information necessary for access to an object owned by said stopping server from said list, and
means for notifying each server connected to the distributed object system of a deletion request for deleting information necessary for access to an object owned by said stopping server from said list, thereby conducting communication between objects in the distributed object system by using the list generated by said deletion means.

11. A server for conducting communication between objects in a distributed object system, comprising:
information collection means for transmitting, to each other server connected to the distributed object system, an information return request for requesting transmission of information necessary for accessing an object owned by the server in question,
generation means for generating a list of information necessary for access to an object in the distributed object system based on information returned from each said server,
means for transmitting said list to each said server,
means for receiving an information return request from other server,
means for transmitting information necessary for access to an owned object to a server as a transmission source of said information return request, and
reception means for receiving a list including information necessary for access to an object owned by each server from a transmission source server of said information return request, wherein
as a list for communication between objects in the distributed object system,
at an initial state, a list generated by said generation means is used and
when receiving a list by said reception means, the list in question is used.

12. The server for conducting communication between objects in a distributed object system as set forth in claim 11, wherein
said information collection means is activated when the server is activated.

13. The server for conducting communication between objects in a distributed object system as set forth in claim 11, further comprising:
means for sensing any server connected to the distributed object system to stop,
deletion means for deleting information necessary for access to an object owned by said stopping server from said list, and
means for notifying each server connected to the distributed object system of a deletion request for deleting information necessary for access to an object owned by said stopping server from said list, thereby conducting communication between objects in the distributed object system by using the list generated by said deletion means.

14. The server for conducting communication between objects in a distributed object system as set forth in claim 11, further comprising:
means for receiving said deletion request, and
means for deleting information necessary for access to an object owned by said stopping server from said list according to said deletion request.

15. A server for conducting communication between objects in a distributed object system, comprising:
means for sensing any server connected to the distributed object system to stop,
deletion means for deleting information necessary for access to an object owned by said stopping server from a list of information necessary for access to an object in the distributed object system, and
means for notifying each server connected to the distributed object system of a deletion request for deleting information necessary for access to an object owned by said stopping server from the list of information necessary for access to an object in the distributed object system which list is owned by each server, thereby conducting communication between objects in the distributed object system by using the list generated by said deletion means.

16. The server for conducting communication between objects in a distributed object system, as set forth in claim 11, further comprising:
means for receiving said deletion request, and
means for deleting information necessary for access to an object owned by said stopping server from said list according to said deletion request.

17. A program for controlling a computer to cause the computer to function as a server for conducting communication between objects in a distributed object system, comprising the functions of:
an information collection function of requesting, from each other server connected to the distributed object system, transmission of information necessary for accessing an object owned by the server in question,
a function of generating a list of information necessary for access to an object in the distributed object system based on information returned from each said server, and
a function of transmitting said list to each said server, thereby conducting communication between objects in the distributed object system by using said list.

18. A program for controlling a computer to cause the computer to function as a server for conducting communication between objects in a distributed object system, comprising the functions of:
receiving, from other server, a return request of information necessary for access to an owned object,
transmitting information necessary for access to an owned object to a server as a transmission source of said return request, and
receiving a list including information necessary for access to an object owned by each server from a return request transmission source server, wherein
said list is used as a list for communication between objects in the distributed object system.

19. A program for controlling a computer to cause the computer to function as a server for conducting communication between objects in a distributed object system, comprising the functions of:
an information collection function of transmitting, to each other server connected to the distributed object system, an information return request for requesting transmission of information necessary for accessing an object owned by the server in question,
a generation function of generating a list of information necessary for access to an object in the distributed object system based on information returned from each said server,
a function of transmitting said list to each said server,
a function of receiving an information return request from other server,
a function of transmitting information necessary for access to an owned object to a server as a transmission source of said information return request, and
a reception function of receiving a list including information necessary for access to an object owned by each server from a server as a transmission source of said information return request, wherein
as a list for communication between objects in the distributed object system,
at an initial state, a list generated by said generation means is used and
when receiving a list by said reception function, the list in question is used.

20. A program for controlling a computer to cause the computer to function as a server for conducting communication between objects in a distributed object system, comprising the functions of:
a function of sensing any server connected to the distributed object system to stop,
a deletion function of deleting information necessary for access to an object owned by said stopping server from a list of information necessary for access to an object in the distributed object system, and
a function of notifying each server connected to the distributed object system of a deletion request for deleting information necessary for access to an object owned by said stopping server from the list of information necessary for access to an object in the distributed object system which list is owned by each server, thereby conducting communication between objects in the distributed object system by using the list generated by said deletion function.
